(19) United States
(12) Patent Application Publication
(10) Pub. No.: US 2007/0244776 A1
(43) Pub. Date: Oct. 18, 2007

(54) Method of compensating employees using stock equity

(76) Inventor: John O'Brien, Short Hills, NJ (US)

Correspondence Address: John O'Brien, 32 Nottingham Road, Short Hills, NJ, 07078, US

(21) Appl. No.: 11/405,718

(22) Filed: Apr. 18, 2006

(51) Int. Cl. G06Q 40/00

(52) U.S. Cl. 705/35

(57) ABSTRACT

This invention comprises a method for defining, establishing and operating a business model, or an augmentation to a business model, that uses a grant of a portion of the equity of a startup company as a component in a deal with a professional service company such as a consulting company. The present invention includes the grant of a portion of the equity in a startup company that serves at least three unique, simultaneous purposes: (1) as inducement to the professional services company to participate in assisting or otherwise supporting the startup; (2) as a cost free component to the professional services company, a portion of which (for example, 50%), is then allocated as a payment budget to the various employee's or agents of the professional services company if and only if they perform work for the startup company; this allocation of stock interest to the individual employee or agent, is in a parallel payment fashion and represents a new and independent way of compensation for those company employees and hence does not factor into any of their current compensation schemes; and (3) once earned and allocated for a particular professional services company employee, this stock then becomes a further inducement to retain the professional services company employee, as they would, in most instances, forfeit their various stock interests of this type if they resign their employment.

### CROSS REFERENCE TO RELATED APPLICATIONS

I claim priority to 14 Apr. 2005 in provisional application 60/671,429 filed 14 Apr. 2005.

### BACKGROUND OF THE INVENTION

1. Field of the Invention

The present invention relates to compensation strategies for businesses that pay employees to act as contractors, consultants, agents or otherwise on behalf of third party persons and entities. This might include companies that specialize in consulting, accounting, legal representation, or other firms which have professional employees that are made available for the benefit of the engaging party.

2. Description of the Prior Art

Today's business environment consists of varied compensation plans. Often this includes only pay or salary. Frequently this includes a wide range of personal benefits such as health benefits, vacation benefits, personal days, and perhaps even stock options in the employing company.

As business markets are cyclical, companies often find they have a problem in the retaining of employees. A situation where a business has a higher than industry average, or an unacceptable number of employees leaving the firm, is known as a retention problem (“Retention Problem”). As different areas of the employment market “heat up” or experience the need for additional employees, many firms raise their compensation offers and thus recruit away employees from other firms.

Specialty Firms (“Specialty Firms”), such as consulting firms or the other types of firms mentioned above, are defined as having large concentrations of similarly skilled employees. These firms are particularly vulnerable to external recruiting when the economy heats up. Under such circumstances, it is not uncommon for these specialty firms to have a Retention Problem.

Specialty Firms often have varying percentages of their employees engaged under contract to various clients. Like hotels, most Specialty Firms rarely, if ever, have a 100% engagement rate. When a full time employee of a Specialty Firm is not engaged by or under contract with a client, that employee or consultant is said to be On The Beach (“On The Beach”).

### SUMMARY OF THE INVENTION

It is one object of the present invention to provide an improved business model which describes a method of providing an additional means of compensation for professional employees of Specialty Firms in a manner that facilitates the retention of those employees and increases the value of the Specialty firm.

It is a further object of the present invention to describe this business model in a manner that it may be easily augmented to an existing company business model as opposed to needing to obviate or replace that existing business model.

It is a further object of the present invention to reduce the time that a professional employee is On The Beach.

It is a further object of the present invention to increase the revenue of the Specialty Firm without increasing either the fixed costs or the variable costs of that firm.

It is a further object of the present invention to increase goodwill for the Specialty Firm.

It is a further object of the present invention to provide Specialty Firms a lucrative method for equity investment in smaller firms that facilitates the sale of On The Beach time.

### BRIEF DESCRIPTION OF THE DRAWINGS

Features and advantages of the present invention will become apparent to those skilled in the art from the following description with reference to the drawings, in which:

FIG. 1 is a diagrammatic presentation of the roles and the actions that impact the ownership of stock interests under the present invention.

FIG. 2 shows the process steps in the new compensation scheme.

### DETAILED DESCRIPTION OF INVENTION AND THE PREFERRED EMBODIMENTS

To overcome the limitations in the prior art, the present invention discloses a method for providing equity compensation rewards, those rewards being staked in various entrepreneurial firms, to employees of Specialty Firms, who perform services for those entrepreneurial firms.

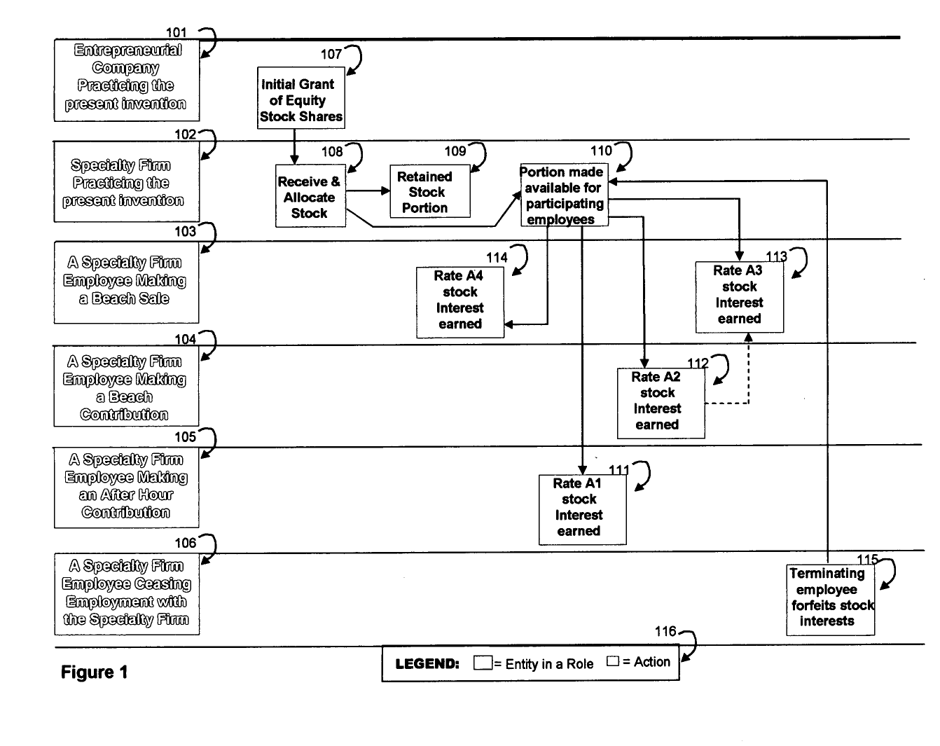

In one of the preferred embodiments of the present invention, FIG. 1 is a diagrammatic presentation of the roles and the actions that change the ownership of stock interests under the present invention. An examination of FIG. 1 yields an understanding of the roles that various entities play in the present invention, and the various actions carried out by those entities. It should be understood that the term “entities” also includes individuals in appropriate circumstances. The legend 116 of FIG. 1 depicts that the dark boxes, which each begin a new row, denote the role being played across that row, while the white boxes, within rows, denote an action point.

On the left portion of FIG. 1 is a column of 6 boxes labeled 101 through 106 and each of those boxes represent and define a role for their respective rows. FIG. 1 depicts how various actions within defined roles result in the transfer of equity stock interest. We now discuss each transition.

FIG. 1 shows four different annotated equity compensation rates, A1, A2. A3, and A4 corresponding respectively to 111, 112, 113, and 114. These rates are associated with four different methods of stock transfer to employees. In a preferred embodiment of the present invention, described later, rates are shown differently and in various potential models. However, depending upon the objectives of the specific Specialty Firm, one or more of these rates may be identical.

The rates of equity compensation can be mapped, for example, to the circumstances under which these services were delivered. For example, consider four different examples:
1. An employee of a Specialty Firm who is already fully billed out, and still manages to do some work, after hours as it were, for the entrepreneurial firm, is defined to earn at rate A1 (“A1”). A contribution of this type is shown at 111 on FIG. 1. At 105, a role is shown for the entire row. This role is that of the employee/consultant making an after hour contribution, that is, the employee is fully billed out and still finds time to contribute.
2. An employee of a Specialty Firm who is On The Beach and contributes some work hours is defined to earn at rate A2 (“A2”). A contribution of this type is shown at 112 on FIG. 1. At 104, a role is shown for the entire row. This role is that of the employee/consultant making contribution while still On The Beach.
3. A special situation occurs when an employee of a Specialty Firm who is On The Beach and while in the process of actively contributing some work hours, is then selected to be called out to a different regular paying customer assignment. Two situations can occur at this point. The entrepreneurial firm may decide to suffer this interruption and seek to mitigate this loss in other ways. Or it may decide to offer to pay the Specialty Firm for a negotiated contract to staff the employee for some minimum time at some agreed price. This represents a conversion of an employee/consultant from an On The Beach state to an on assignment or under contract state. This is shown to earn at rate A3 (“A3”). A contribution of this type is shown at 113 on FIG. 1. Note that the source of this action always begins with a contribution at 112. This is because a conversion of an On The Beach contribution occurs during the 112 to 113 transition. At 103, a role is shown for the entire row. This role is that of the employee/consultant making contribution while either commencing from an On The Beach status, an action at 114 to be discussed next, or transitioning from a previous On The Beach and contributing role, ie 112, to 113 action.
4. A second type of On The Beach sale occurs when the entrepreneurial firm may decide to simply purchase services from the Specialty Firm in the usual fashion 114 that the Specialty Firm offers all potential customers. This is shown to earn at rate A4 (“A4”). Specialty Firms may want to impose a defined blackout period following the conclusion of a work agreement, between the entrepreneurial firm and the employee/consultant, and the commencement of the same employee/consultant working for the same entrepreneurial firm under any rate different than A4.

We have discussed examples of some different ways that entrepreneurial firm stock equity may be earned by employee/consultants of the Specialty firm. We discussed Now we discuss one embodiment of the entire flow of stock interests.

At the beginning of a relationship between the entrepreneurial firm and the Specialty firm a certain portion of stock in the entrepreneurial firm is granted to the Specialty Firm as part of the over all deal that is negotiated and reached. This action is shown as 107 and it occurs in the role that the entrepreneurial firm plays in practicing the present invention, 101.

The Specialty Firm that is also practicing the present invention 102 accepts that stock and allocates it 108 into a portion that it wants to retain 109 for the Specialty Firm itself, and a portion that will be made available 110 to be earned by various participating employees/consultants as a form of additional compensation for their contributed efforts on behalf of the entrepreneurial firm.

Actions 111, 112, 113, and 114, discussed previously, define stock interests at different rates that are transferred to employee/consultants. The actual rate per hour in each case is not as significant as the fact that there is a payment relationship established. In other words, that actual rate may be a factor of many things, for example, the seniority and skill level of the employee/consultant, the amount of stock originally granted in 107, the amount of stock transferred for participating employees in 110, the salary level and number of years worked for the Specialty Firm, the perceived value of the entrepreneurial firm, to name just a few. That there is a relationship between stock received by the employee/consultant and work performed or contributed is the overridingly significant factor. The relative rates suggested above between A1, A2, A3, and A4 are suggestions of a preferred embodiment and the inventors realize that different situations in different firms may suggest that some rates differ or that some rates be zero.

A feature of the present invention is an intention to distribute this earned stock interest to the employee/consultant over time. In other words this interest has a vesting period. The exact vesting period details are not as significant as the fact that there be a vesting period that has a series of near term rewards. One example of a preferred embodiment of a vesting period is a series of distributed shorter time periods, where shares are realized every three months, over a time of 3 months, occurring over a 2 year running time period. This would work as follows

At the end of month 3, 12.5% (corresponding to the ratio of 3 months to 24 months) of the cumulative 3 month earned shares become vested. This is the first of 8 vesting sub-periods, totaling 24 months, that will complete the transfer from the Specialty Firm to the employee/consultant.

Any stock interest earned in the next 3 month period by the same employee/consultant, would start another 24 month vesting period with the first three months of that period being the time when the stock interest was earned. Thus every 3 months begins a new two year cycle for any stock interest earned during those three months.

Table 1 below presents summary data for an example of an employee/consultant who earned 200, 333, and 507 shares of stock interest over a three month period.

TABLE 1
Entrepreneurial Firm 1

| | Month | | |
|---|---|---|---|
| | 1 | 2 | 3 |
| Shares Earned Per Month | 200 | 333 | 507 |
| Cumulative Shares | 200 | 533 | 1040 |
| Shares Available for Vesting | | | 1040 |
| Vesting Portion (3/24) | | | 0.125 |
| Shares vested this period | | | 130 |
| Vested Cumulative Shares | | | 130 |

Table 2 below presents summary data for the second 3 month period. Note that the cumulative vested shares increases to 260 shares and that, by definition, there are no added shares earned during this 3 month period. Any such earned shared interest would begin a new two year cycle of their own.

TABLE 2
Entrepreneurial Firm 1

Month

| | 4 | 5 | 6 |
|---|---|---|---|
| Shares Earned Per Month | 0 | 0 | 0 |
| Cumulative Shares | 0 | 0 | 1040 |
| Shares Available for Vesting | | | 1040 |
| Vesting Portion (3/24) | | | 0.125 |
| Shares vested this period | | | 130 |
| ested Cumulative Shares | | | 260 |

Table 3 below presents summary data for the eighth and last 3 month period. Note that the cumulative shares reach the total number of shares at the end of this period.

TABLE 3
Entrepreneurial Firm 1

| | Month | | |
|---|---|---|---|
| | 22 | 23 | 24 |
| Shares Earned Per Month | 0 | 0 | 0 |
| Cumulative Shares | 0 | 0 | 1040 |
| Shares Available for Vesting | | | 1040 |
| Vesting Portion (3/24) | | | 0.125 |
| Shares vested this period | | | 130 |
| Vested Cumulative Shares | | | 1040 |

The effect of this vesting scheme on the employee/consultant is threefold: (i) there is almost an immediate gain, only three months away, from when he or she starts actually vesting stock, (ii) there is always a two year horizon when any stock interest earned during this quarter will complete vesting, and (iii) there is a vesting event every quarter.

This means that there is never a good time for the employee/consultant to plan to leave the firm, as 5 minutes into the new quarter, he or she is always less than three months away from the next vesting event. An employee who ceases to be employed 107 by the Specialty Firm 115 forfeits all right and interest in any non-vested stock interest. This action is shown in FIG. 1. At 107, a role is shown for the entire row. This role is that of the employee/consultant who for any reason ceases to be an employee of the Specialty Firm.

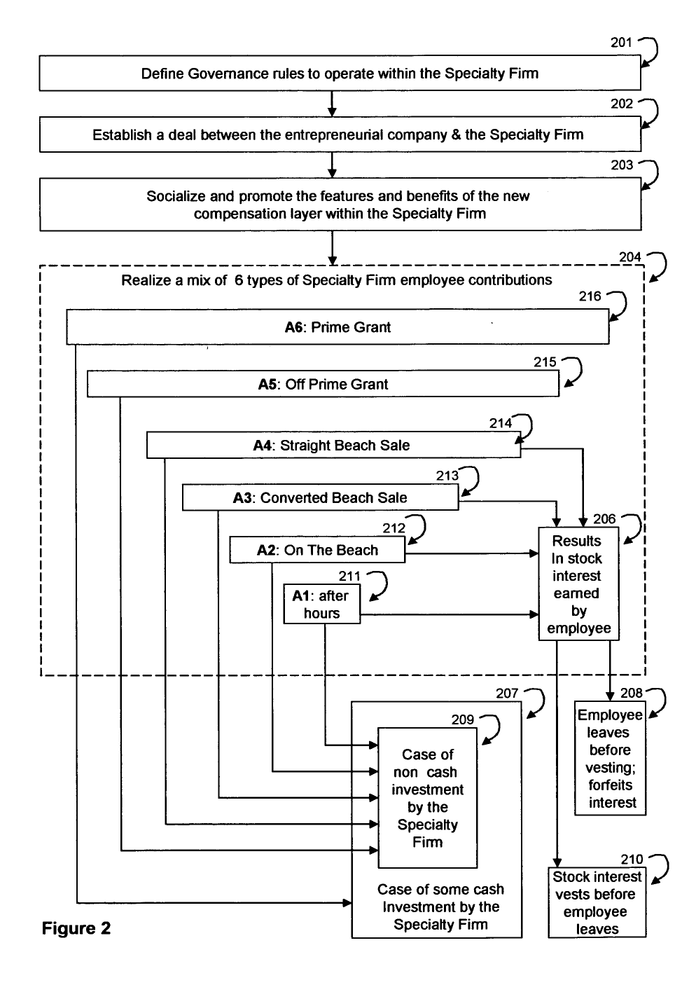

FIG. 2 shows the process steps in the new compensation scheme. We now discuss each element in this scheme.

The process starts when the Specialty Firm defines some Governance rules 201, consistent with their other operational rules and procedures, about various parameters and operational constraints. These rules pertain to the selection criteria to be used to evaluate entrepreneurial firms and the administration and oversight of the associated stock interests within the firm. The exact specification of these rules is outside the scope of the present invention as they will be particular to each Specialty Firm, but for example, these rules might include: (1) the type of business that the entrepreneurial firm must be engaged in, (2) the stage of development of the entrepreneurial firm, (3) whether the Specialty Firm elects to invest any cash, or if the investment is 100% non-cash, (4) target rate of returns on cash investments, (5) degree of oversight (if any) by the Specialty Firm in monitoring the entrepreneurial firm, (6) policies on confidentiality, (7) policies on introductions of the entrepreneurial firm to Specialty Firm clients, (8) policies on how the publication of the needs of entrepreneurial firm partners are disseminated within the Specialty Firm, (9) policies on how employee/consultants volunteer and are selected for participation and (10) any ethical rules, laws or regulations that may apply.

The entrepreneurial firm and Specialty Firm must agree on and establish a deal 202. Like all deals between two companies, this needs to factor in the size and other complexities. The specification of this deal is outside the scope of the present invention, however, this deal should involve the granting of a stock interest from the entrepreneurial firm or a related company to the Specialty Firm. A preferred embodiment includes that this grant be actual stock, another embodiment includes that it be warrants for stock at a nominal value. Still another embodiment includes the grant of stock options to be exercised upon the achievement of certain pre-defined performance criteria.

The Specialty Firm needs to socialize and promote 203 the benefits and features of this new compensation layer within the Specialty Firm. This might be accomplished in many ways, for example, by memo, or newsletter, or publication on an intra-net site, by word of mouth, by announcement at company meetings, or all of these methods, but it needs to be accomplished. The specific manner(s) are likely to be different for different Specialty Firms.

Once a deal is in operation 202 and details about the new compensation program are publicized 203, and rules are in place 201 to determine how an employee/consultant might signup to participate, then there are six ways 204 for an employee/consultant to contribute work efforts to the entrepreneurial firm.

The employee/consultant who is fully engaged on an existing assignment for an existing client, may wish to contribute efforts after hours at night or on weekends 211. This kind of contribution constitutes the most valuable situation for the Specialty Firm as the employee/consultant is fully employed and he or she is also creating value for the partner entrepreneurial firm. This contribution should merit the highest rate of stock earning and is referred to as A1 (“A1”). This is shown in 211 and 111.

The employee/consultant who is On The Beach and therefore is without an existing assignment for an existing client, may wish to contribute efforts while On The Beach and/or after hours at night or on weekends 212. This kind of contribution helps mitigate against the costs of carrying the employee/consultant by the Specialty Firm. This contribution should merit the third highest rate of stock earning and is referred to as A2 (“A2”). This is shown in 212 and 112.

The employee/consultant who is On The Beach and already contributing efforts while On The Beach, may face a situation where he or she is selected for another potential assignment. At that point the entrepreneurial firm has the option to convert that employee/consult from a contributor to an engaged and paid resource. This means the entrepreneurial firm would pay for the time of the employee/consultant via a formal engagement that was negotiated with the Specialty Firm and specified duration and cost. If the entrepreneurial firm does not elect to engage and pay for the employee/consultant than the employee/consultant follows the normal interview process to determine if they are engaged by the potential client. If so they go; if not they remain On The Beach and hence may resume their contribution to the entrepreneurial firm. In the event that the entrepreneurial firm formally engages the employee/consultant at this point, this is said to be a converted Beach sale 213. This kind of contribution actually helps to sell services to entrepreneurial firms for the Specialty Firm. This contribution should merit the second highest rate of stock earning and is referred to as A3 (“A3”). This is shown in 213 and 113.

The employee/consultant who is On The Beach and therefore is without an existing assignment for an existing client, may be selected for a normal engagement by the entrepreneurial firm. This contribution should merit the lowest rate of stock earning and is referred to as A4(“A4”). This is shown in 214 and 114.

There may be deals between the entrepreneurial firm and Specialty firm that involve a grant of services from the Specialty Firm to the entrepreneurial firm. These may take the form of a specified number of hours of employee/consultant time. These grants might take any number of different forms, two of which are expressed as dollar amounts. Grants are considered prepaid amounts.

A prime grant 216 would involve an employee/consultant who is On The Beach and therefore is without an existing assignment for an existing client, who may be selected for a normal engagement by the entrepreneurial firm. Under this grant there is no cost to the entrepreneurial firm for using this employee/consultant up to the limit of the grant. This employee/consultant is considered under engagement. In a preferred embodiment, the stock interest earned by the employee/consultant is zero under this approach defined as rate A6(“A6”).

An off prime grant 215 would involve an employee/consultant who is On The Beach and therefore is without an existing assignment for an existing client, who may be selected for a special engagement by the entrepreneurial firm. What is special is that the employee/consultant may still be selected to interview and go on assignment to other potential clients. Like the situation describe earlier associated with 112, the entrepreneurial firm may elect at that point to pay for the employee/consultant to continue. Under this grant there is no cost to the entrepreneurial firm for using this employee/consultant up to the limit of the grant—provided the employee/consultant is not selected for another client. This employee/consultant is considered under special engagement. In the preferred embodiment, the stock interest earned by the employee/consultant is zero under this approach defined as rate A5(“A5”). Even though this case is considered prepaid, there is no realized cost, nor is there an opportunity cost, to the Specialty Firm as the employee/consultant is On The Beach.

Note that rates A1, 211 (and 111), and, A2, 212 (and 112), and A3, 213 (and 113), and A4, 214 (and 114), all result in stock interest earned by the employee/consultant 206 as shown in FIG. 2.

If an employee leaves the Specialty Firm for any reason before his or her stock interest vests, then they forfeit any unvested interest 208.

Stock interest earned by the employee will vest 210 periodically. An example of a vesting scheme was discussed earlier.

As discussed earlier, it is envisioned that the present invention can work within at least two different scenarios: (1) one where no cash is invested in the entrepreneurial firm by the Specialty Firm, and (2) one where the Specialty Firm elects to invest cash and possibly other non cash elements. While the specification of those deals is outside the scope of the present invention, we note that the present invention is designed to accommodate either scenario and other scenarios that accomplish that same key results

In FIG. 2 element 207 shows the general case where there are both cash and non cash investment elements. The contribution 216 is considered a cash element as while it itself does not involve a direct expenditure by the Specialty Firm, it nevertheless represents a potential opportunity cost of a sale, as while a resource is committed to an entrepreneurial firm engagement it can not be used elsewhere.

As a subset of the 207 general case, it includes the five contributions, 211 through 215. These are considered as non-cash elements, because they result in neither a direct expenditure by the Specialty Firm nor an opportunity cost of a sale.

In the above description, reference is made to the accompanying drawings which form a part hereof, and which illustrate an embodiment of the present invention. It is understood that other embodiments may be utilized and structural and operational changes may be made without departing from the scope of the present invention.

For simplicity and illustrative purposes, the principles of the present invention are described by referring to the preferred embodiment. The invention includes an additional compensation level using stock equity. However, one of ordinary skill in the art would readily recognize that the same principles are equally applicable to, and can be implemented in, another reward system or some other financial interest instrument that may exist or may be designed in the future and that any such variation would be within such modifications that do not depart from the true spirit and scope of the present invention. For example a school system might benefit from the principles taught in the present invention if we substitute training programs for stock interests, and substitute volunteer school program work for entrepreneurial firm contributions.

Nothing in this specification should be understood to limit this invention to the required use of stock equity as a measure of reward. Stock interest is merely an example of a convenient reward strategy.

In summary, the present invention presents a method for providing businesses with a new ability to discourage valued employees from leaving the firm. In addition, the present invention includes a way to facilitate and create new sales from the ON The Beach or idle time of employees.

We claim:

1. A method of further compensating employees which results in an inducement to remain as employees comprising:
providing a means for establishing a deal with another company including obtaining a stock interest in that company;
providing a means for transferring a portion of that stock interest to specific employees who contribute work efforts on behalf of the other company with which the deal was made;
providing a means for vesting the employees stock interest.
